(19) United States
(12) Patent Application Publication
(10) Pub. No.: US 2022/0029932 A1
(43) Pub. Date: Jan. 27, 2022

(54) ELECTRONIC SYSTEM FOR PROCESSING TECHNOLOGY RESOURCE IDENTIFIERS AND ESTABLISHING DYNAMIC CONTEXT-BASED CROSS-NETWORK COMMUNICATIONS FOR RESOURCE TRANSFER ACTIVITIES

(71) Applicant: Bank of America Corporation, Charlotte, NC (US)

(72) Inventors: Aparna Pattyreddy, Hyderabad (IN); Govinda Rajulu Nelluri, Hyderabad (IN)

(73) Assignee: Bank of America Corporation, Charlotte, NC (US)

(21) Appl. No.: 16/935,724

(22) Filed: Jul. 22, 2020

(51) Int. Cl. H04L 12/927; H04L 12/911; H04L 12/923; G06N 20/00; G06N 7/00

(52) U.S. Cl. CPC H04L 47/801; H04L 47/808; G06N 7/005; H04L 47/762; G06N 20/00; H04L 47/781

(57) ABSTRACT

Embodiments of the invention are directed to a system, method, and computer program product for processing technology resource identifiers and establishing dynamic context-based cross-network communications for resource transfer activities. The system first receives a transmission that a user has requested a resource transfer. The system then determines, based on a universal identifier associated with a second user, an identifier of a resource account associated with the second user. The system then transmits a request for the resource transfer to a resource processing system.

### FIELD OF THE INVENTION

The present invention is directed to, in general, a novel, proactive approach for cross-network communications for resource transfer activities. Specifically, embodiments of the present invention are directed to utilizing one or more technology resource identifiers to establish cross-network communications to facilitate one or more resource transfer activities via one or more communications networks.

### BACKGROUND

Typically, to transfer resources from a first resource to a second resource requires a first identifier that identifies the first resource and a second identifier that identifies the second resource in order to complete the transfer. Thus, to complete a transfer between the first recourse and the second resource, multiple identifiers need to be known. However, this requires that a person and/or an entity desiring to make a transfer know the multiple identifiers. Further, if the first resource is located on a communications network separate from the second resource, differing protocols between the two communications networks can mean that the first identifier is incompatible on the second network. For example, the first communications network may not be able to convert the second identifier if the second identifier is in a format that is incompatible with the first communications network. Thus, to complete a resource transfer between the two networks, not only do the two identifiers need to be known, but also the varying protocols of the different communications networks to effectuate the transfer of resources.

Accordingly, there is a need for systems and methods for processing technology resource identifiers and establishing dynamic context-based cross-network communications for resource transfer activities to improve resource transfers across multiple communications networks.

The previous discussion of the background to the invention is provided for illustrative purposes only and is not an acknowledgement or admission that any of the material referred to is or was part of the common general knowledge at the priority date of the application.

### SUMMARY

The present disclosure provides a novel solution to the foregoing shortcomings of conventional systems and provides improvements to technology directed to utilizing one or more technology resource identifiers to establish cross-network communications to facilitate one or more resource transfer activities via one or more communications networks. In one aspect, the present invention is directed to in general a system for utilizing one or more technology resource identifiers to establish cross-network communications to facilitate one or more resource transfer activities via one or more communications networks, a corresponding method, and computer program product. The system may include at least one processing device operatively coupled to at least one memory device and at least one communication device connected to a distributed network. The system may also include a module stored in the at least one memory device comprising executable instructions that when executed cause the processing device and hence the system to perform one or more functions described below. In one embodiment, the system is configured to receive from a first resource application of a first networked device a first transmission that a first user associated with the first networked device has requested a resource transfer. The first transmission can indicate a quantity of a resource to transfer from a first resource account associated with a first resource network and can also indicate a universal identifier associated with a second user. The system can be configured to determine, based on the universal identifier associated with the second user, whether a second resource account associated with the universal identifier is associated with the first resource network. The system can also be configured to, if the second resource account is associated with the first resource network, determine an identifier of the second resource account associated with the first resource network. The system can be further configured to, if the second resource account is not associated with the first resource network, transmit to one or more additional resource networks a second transmission that indicates the universal identifier associated with the second user. The system can be configured to receive from at least one of the one or more additional resource networks the identifier of the second resource account associated with the second user. The system can also be configured transmit to a resource processing system a request for the resource transfer, wherein the request comprises an identifier associated with the first resource account, the identifier associated with the second resource account, and the quantity of the resource to transfer from the first resource account to the second resource account. The system can be configured to receive from the resource processing system a third transmission that indicates that the resource transfer from the first resource account to the second resource account has been processed. Further, the system can be configured to transmit to the first resource application of the first network device a fourth transmission that indicates the resource transfer has been processed.

In another embodiment, and in combination with any of the previous embodiments, if the second resource account is not associated with the first resource network, the system is further configured to determine contextual data associated with the first user and the requested resource transfer. The system can be further configured to determine, based on the contextual data, a probable additional resource network of the one or more additional resource networks that is more likely to be associated with the second resource account. The system can be configured to also transmit to the probable additional resource network the universal identifier associated with the second user. The system can also be configured to receive from the probable additional resource network the identifier of the second resource account associated with the second user.

In another embodiment, and in combination with any of the previous embodiments, the contextual data comprises at least one of a location associated with the first user, a location associated with the second user, a location associated with the first networked device, a time associated with the first transmission, a language associated with the first user, or a language associated with the second user. The system can be further configured to utilize machine learning to determine, based on the contextual data, the probable additional resource network.

In another embodiment, and in combination with any of the previous embodiments, the first transmission includes a universal identifier associated with the first user, and the system can be further configured to determine, based on the universal identifier associated with the first user, two or more resource accounts associated with the first user. The system can also be configured to transmit to the first networked device a request for the first user to indicate a preferred resource account of the two or more resource accounts associated with the first user to utilize for the resource transfer. Additionally, the system can be configured to receive from the first network device a fifth transmission that indicates the preferred resource account. The system can be configured to also determine an identifier associated with the preferred resource account, wherein the identifier associated with the preferred resource account is transmitted to the resource processing system.

In another embodiment, and in combination with any of the previous embodiments, the system is further configured to determine, based on the universal identifier associated with the second user, two or more resource accounts associated with the second user. The system can also be configured to transmit to the first networked device a request for the first user to indicate a preferred resource account of the two or more resource accounts associated with the second user to utilize for the resource transfer. The system can be configured to also receive from the first network device a fifth transmission that indicates the preferred resource account. The system can be further configured to determine an identifier associated with the preferred resource account, wherein the identifier associated with the preferred resource account is transmitted to the resource processing system.

In another embodiment, and in combination with any of the previous embodiments, the system is configured to determine, based on the universal identifier associated with the second user, two or more resource accounts associated with the second user. The system can also be configured to transmit to a second networked device associated with the second user a request for the user to indicate a preferred resource account of the two or more resource accounts associated with the second user to utilize for the resource transfer. Also, the system can be configured to receive from the second networked device a fifth transmission that indicates the preferred resource account. The system can be configured to determine an identifier associated with the preferred resource account, wherein the identifier associated with the preferred resource account is transmitted to the resource processing system.

In another embodiment, and in combination with any of the previous embodiments, the system can be configured to determine a respective communications protocol for each of the one or more additional resource networks. The system can also be configured to determine, based on the respective communications protocols, a respective second transmission for each of the one or more additional resource networks. The system can be configured to also transmit the respective second transmissions for each of the one or more additional resource networks. The system can be further configured to receive from at least one of the additional resource networks the identifier of the second resource account.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 schematically depicts an electronic activity processing system and environment, in accordance with an aspect of the present invention;

FIG. 2 schematically depicts a high-level process flow for utilizing one or more technology resource identifiers to establish cross-network communications to facilitate one or more resource transfer activities via one or more communications networks;

FIG. 3 schematically depicts an illustrative representation and processing environment of utilizing one or more technology resource identifiers to establish cross-network communications to facilitate one or more resource transfer activities via one or more communications networks, in accordance with some embodiments of the invention;

FIG. 4 schematically depicts an illustrative representation and processing environment of a resource network gateway, in accordance with some embodiments of the invention; and

FIG. 5 schematically depicts an illustrative representation of a resource application user interface, in accordance with some embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In some embodiments, an “entity” refers to an organization, a company, a group, an institute, a business or the like associated with initiating and/or performing electronic activities. Typically, the entity comprises systems, devices, applications and/or the like for initiating and/or performing electronic activities. In some embodiments, the entity initiates and/or performs electronic activities in response to receiving instructions from an associated user. In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, or the like. The account is associated with and/or maintained by an entity. In other embodiments, an “entity” may not be a financial institution. Examples for non-financial entities include cloud computing systems, database systems, block chain systems for data processing, and the like.

Unless specifically limited by the context, an “electronic activity”, “user activity”, “transaction” or “activity” refers to activities associated with electronic resources, such as the user's resources. In some embodiments, the electronic activity refers to resource transfers between resources, e.g., a transfer of a resource value from a first resource and a second resource. For example, the electronic activity may refer to transmission of resource value comprising predetermined data (e.g. files, text, images, and the like) from a first resource (e.g., a user device, a database, a server, a cloud storage system, and the like) to a second resource (e.g., another device, database, and the like). Typically, a first system (e.g., a user device or a networked device), for example, based on receiving instructions from a user, transmits activity parameters (e.g., location of the file, time of transmission, unique identifier of the source resource system, certificates of the target resource system, authentication information, and the like) to a recipient system (e.g., a system associated with one or more of the resources, an entity system, and the like) which then performs the electronic activity (transfer of the file from the source resource system to the target resource system). As another example, in some embodiments, the electronic activity refers to transfer of a resource value comprising financial resources (e.g. a predetermined transfer amount) from a first resource (e.g., a source user account) to a second resource (e.g., another target account). Typically, a first system (e.g., a user device), for example, based on receiving instructions from a user, transmits activity parameters (e.g., the transfer amount, time and date of the transfer, unique identifiers of the source user account and the target user account, and the like) to a recipient system (e.g., a financial institution associated with the source account and/or the target account) which then performs the electronic activity (transfer of the predetermined amount from the source user account to the target account).

As such, in some embodiments, an electronic activity or a user activity may refer to a purchase of goods or services, a return of goods or services, a resource transaction, a credit transaction, or other interaction involving a user's resources (e.g., a bank account). As another example, in some embodiments, a user activity may refer to viewing account balances, modifying user information and contact information associated with an account, modifying alert/notification preferences, viewing transaction/activity history, transferring/redeeming loyalty points and the like. In some embodiments, the user activity is associated with an entity application stored on a user device, for example, a digital wallet application, a mobile/online banking application, a merchant application, a browser application, a social media application and the like. Typically, a user activity is an electronic transaction or electronic activity in which the user is employing a mobile device, computing device, or other electronic device to initiate, execute and/or complete the activity.

As used herein, an “online banking account” is an account that is associated with one or more user accounts at a financial institution. For example, the user may have an online banking account that is associated with the user's checking account, savings account, investment account, and/or credit account at a particular financial institution. Authentication credentials comprising a username and password are typically associated with the online banking account and can be used by the user to gain access to the online banking account. The online banking account may be accessed by the user over a network (e.g., the Internet) via a computer device, such as a personal computer, laptop, or mobile device (e.g., a smartphone or tablet). The online banking account may be accessed by the user via a mobile or online banking website or via a mobile or online banking application. A customer may access an online banking account to view account balances, view transaction history, view statements, transfer funds, and pay bills. More than one user may have access to the same online banking account. In this regard, each user may have a different username and password. Accordingly, one or more users may have a sub-account associated with the online banking account.

A “user” may be an individual or group of individuals associated with an entity that provides the system for assessing network authentication requirements based on situational instance. In some embodiments, the “user” may be a financial institution user (e.g., an account holder or a person who has an account (e.g., banking account, credit account, or the like)). In one aspect, a user may be any financial institution user seeking to perform user activities associated with the financial institution or any other affiliate entities associated with the financial institution. In some embodiments, the user may be an individual who may be interested in opening an account with the financial institution. In some other embodiments, a user may be any individual who may be interested in the authentication features offered by the financial institution/entity. In some embodiments, a “user” may be a financial institution employee (e.g., an underwriter, a project manager, an information technology specialist, a manager, an administrator, an internal operations analyst, bank teller or the like) capable of operating the system described herein. For purposes of this invention, the term “user” and “customer” may be used interchangeably.

With advancements in technology infrastructures and wireless communication implementation, electronic devices such as transaction terminals such as point of sale terminals, portable multi-function devices, such as laptop computers, tablet computers, mobile phones, smart phones, wearable devices and the like are common. Typically, individuals may also have a mobile user device with them. These electronic devices may enable performance of user activities (e.g., financial activities, purchases, resource transfers, accessing resource data stored at other systems and databases and the like) based on requisite authorization. These electronic devices may also be configured to allow the user to perform the one or more user activities, transactions or resource transfers through an application, accept authentication credentials from the user, transmit authentication credentials for validation at external systems.

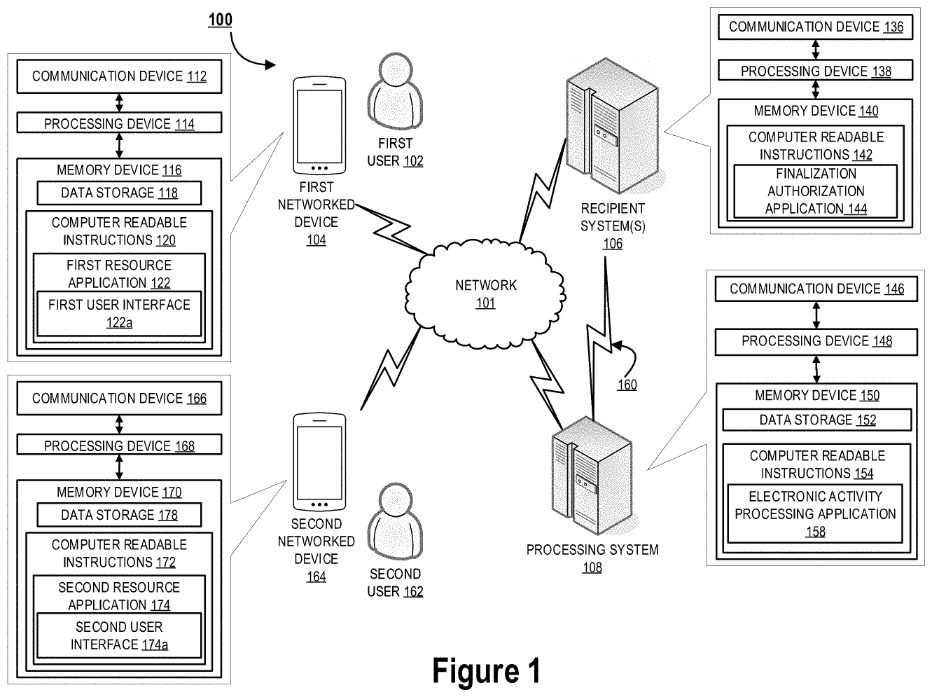

FIG. 1 illustrates an electronic activity processing system environment 100, in accordance with some embodiments of the present invention. FIG. 1 provides a unique system that includes specialized servers and systems, communicably linked across a distributive network of nodes required to perform the functions of processing resource transfer activities.

As illustrated in FIG. 1, a processing system 108, or electronic activity processing system 108 or application server (e.g., a financial institution system 108) is operatively coupled, via a network 101 to user devices such as a first networked device 104, a second networked device 164, to the recipient system 106 (e.g., another second financial institution system 106) and/or to one or more secondary systems. In this way, the processing system 108 can send information to and receive information from the user devices such as a first networked device 104, a second networked device 164, the recipient system 106, and one or more secondary systems. FIG. 1 illustrates only one example of an embodiment of the system environment 100, and it will be appreciated that in other embodiments one or more of the systems, devices, or servers may be combined into a single system, device, or server, or be made up of multiple systems, devices, or servers.

The network 101 may be a system specific distributive network receiving and distributing specific network feeds and identifying specific network associated triggers. The network 101 may also be a global area network (GAN), such as the Internet, a wide area network (WAN), a local area network (LAN), or any other type of network or combination of networks. The network 101 may provide for wireline, wireless, or a combination wireline and wireless communication between devices on the network 101. In some embodiments, the network 101 may enable communication between devices thorough near-field communication, transmission of electromagnetic waves, sound waves or any other suitable means.

In some embodiments, the first user 102 is an individual that has a user device, i.e., the first networked device 104, such as a mobile phone, tablet, or the like and who seeks to perform one or more electronic activities or user activities. In some embodiments, the second user 162 is another individual that has a user device, i.e., the second networked device 164, such as a mobile phone, tablet, or the like and who seeks to perform one or more electronic activities or user activities.

FIG. 1 also illustrates the first networked device 104. The first networked device 104 (also referred to as a first user device or a user device, typically associated with the first user 102) may refer to a device or a combination of devices that are configured to capture (i.e., receive and/or process) one or more instructions, inputs, authentication credentials, and the like from the user 102 such as a computing device (e.g., a mobile device, a smart phone, a laptop computer and/or another computing device), smart devices (e.g., smart TVs, smart doors, smart speakers, personal digital assistant devices), wearable devices (e.g., smart watches, fitness devices, virtual/augmented reality devices), GPS devices, proximity/location sensors/beacon devices, visual capture devices and/or the like to capture authentication credentials associated with the user. The first networked device 104 may be, for example, a desktop personal computer, a mobile system, such as a cellular phone, smart phone, personal data assistant (PDA), laptop, or the like. The first networked device 104 generally comprises a communication device 112 comprising input/output devices and/or sensors, a processing device 114, and a memory device 116. The first networked device 104 may comprise other devices that are not illustrated, configured for location determination/navigation (GPS devices, accelerometers and the like), for authentication (fingerprint scanners, microphones, iris scanners and the like), for image capture (cameras, AR devices and the like), for display (screens, hologram projectors and the like), and other purposes. The first networked device 104 is a computing system that enables the user to perform one or more user activities, e.g., initiating one or more electronic activities for resource transfers, resource requests, and the like. The processing device 114 is operatively coupled to the communication device 112 and the memory device 116. The processing device 114 uses the communication device 112 to communicate with the network 101 and other devices on the network 101, such as, but not limited to the processing system 108. As such, the communication device 112 generally comprises a modem, server, or other device for communicating with other devices on the network 101.

The first networked device 104 (also referred to as a first user device or a user device, typically associated with the first user 102) comprises computer-readable instructions 120 and data storage 118 stored in the memory device 116, which in one embodiment includes the computer-readable instructions 120 of a first resource application 122. In some embodiments first networked device 104 may refer to multiple user devices that may be configured to communicate with each other, with the processing system and/or other systems via the network 101. In some embodiments, the processing system 108 transmits the application 122 to and/or causes the processing device 114 to install/store the first resource application 122 on the first networked device 104. In some embodiments, the first resource application 122, when executed by the processing device 114 is configured to cause the first networked device 104 to perform one or more steps described herein. In some embodiments, the first resource application 122 is similar to the electronic activity processing application 158 described below. The first resource application 122 may be a standalone application configured for receiving activity data/instructions associated with an electronic activity from a user (typically via the first user interface 122a of the first resource application 122), transmitting electronic activity data and/or generating a static activity data set as described herein, or the first resource application 122 may refer to one or more existing applications on the user device that are configured to perform one or more of these steps. In some embodiments, the first resource application 122 associated with the first user 102 may be associated with a resource network application structured for person-to person (P2P) resources and/or real time resource payment, with the second user 162 being a part of the same resource network and having a corresponding resource network application structured for person-to person (P2P) resources and/or real time resources payment (second resource application 174). In some embodiments the processing system 108 and/or a financial institution system may transmit control signals to the user device, configured to cause the first resource application 122 to perform one or more functions or steps associated with electronic activity processing, for example, causing the application to trigger one or more sensors or input devices of the first networked device 104 to capture an authentication credential based on instructions receiving in an capture signal from the processing system 108, to cause the first networked device 104 to request user input/information from the first user 102, and the like.

FIG. 1 also illustrates the second networked device 164. The second networked device 164 (also referred to as a second user device or a user device, typically associated with the second user 162) may refer to a device or a combination of devices that are configured to capture (i.e., receive and/or process) one or more instructions, inputs, authentication credentials, and the like from the second user 162 such as a computing device (e.g., a mobile device, a smart phone, a laptop computer and/or another computing device), smart devices (e.g., smart TVs, smart doors, smart speakers, personal digital assistant devices), wearable devices (e.g., smart watches, fitness devices, virtual/augmented reality devices), GPS devices, proximity/location sensors/beacon devices, visual capture devices and/or the like to capture authentication credentials associated with the user. The second networked device 164 may be, for example, a desktop personal computer, a mobile system, such as a cellular phone, smart phone, personal data assistant (PDA), laptop, or the like. The second networked device 164 generally comprises a communication device 166 comprising input/output devices and/or sensors, a processing device 168, and a memory device 170. The second networked device 164 may comprise other devices that are not illustrated, configured for location determination/navigation (GPS devices, accelerometers and the like), for authentication (fingerprint scanners, microphones, iris scanners and the like), for image capture (cameras, AR devices and the like), for display (screens, hologram projectors and the like), and other purposes. The second networked device 164 is a computing system that enables the user to perform one or more user activities, e.g., initiating one or more electronic activities for resource transfers, resource requests, and the like. The processing device 168 is operatively coupled to the communication device 166 and the memory device 170. The processing device 168 uses the communication device 166 to communicate with the network 101 and other devices on the network 101, such as, but not limited to the processing system 108. As such, the communication device 166 generally comprises a modem, server, or other device for communicating with other devices on the network 101.

The second networked device 164 (also referred to as a second user device or a user device, typically associated with the second user 162) comprises computer-readable instructions 172 and data storage 178 stored in the memory device 170, which in one embodiment includes the computer-readable instructions 172 of a second resource application 174. In some embodiments, the second networked device 164 may refer to multiple user devices that may be configured to communicate with each other, with the processing system and/or other systems via the network 101. In some embodiments, the processing system 108 transmits the application 174 to and/or causes the processing device 168 to install/store the second resource application 174 on the user device 164. In some embodiments, the second resource application 174, when executed by the processing device 168 is configured to cause the second networked device 164 to perform one or more steps described herein. In some embodiments, the second resource application 174 is similar to the electronic activity processing application 158 described below. The second resource application 174 may be a standalone application configured for receiving activity data/instructions associated with an electronic activity from a user (typically via the second user interface 174a of the second resource application 174), transmitting electronic activity data and/or generating a static activity data set as described herein, or the second resource application 174 may refer to one or more existing applications on the user device that are configured to perform one or more of these steps. In some embodiments, the second resource application 174 associated with the second user 162 may be associated with a resource network application structured for person-to person (P2P) resources and/or real time resources distribution, with the first user 102 being a part of the same resource network and having a corresponding resource network application structured for person-to person (P2P) resources and/or real time resource distribution (first resource application 122). In some embodiments the processing system 108 and/or a financial institution system may transmit control signals to the user device, configured to cause the second resource application 174 to perform one or more functions or steps associated with electronic activity processing, for example, causing the application to trigger one or more sensors or input devices of the second networked device 164 to capture an authentication credential based on instructions receiving in an capture signal from the processing system 108, to cause the second networked device 164 to request user input/information from the second user 162, and the like.

As further illustrated in FIG. 1, the processing system 108 or the electronic activity processing system 108 generally comprises a communication device 146, a processing device 148, and a memory device 150. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 148 is operatively coupled to the communication device 146 and the memory device 150. The processing device 148 uses the communication device 146 to communicate with the network 101 and other devices on the network 101, such as, but not limited to the recipient system 106, the user device(s) 104 and the secondary system(s) 110. As such, the communication device 146 generally comprises a modem, server, or other device for communicating with other devices on the network 101.

As further illustrated in FIG. 1, the processing system 108 comprises computer-readable instructions 154 stored in the memory device 150, which in one embodiment includes the computer-readable instructions 154 of an electronic activity processing application 158. In some embodiments, the memory device 150 includes data storage 152 for storing data related to the system environment, but not limited to data created and/or used by the electronic activity processing application 158. In some embodiments, executing the computer readable instructions of the electronic activity processing application 158 causes the processing device 148 to perform one or more steps for electronic activity processing described herein. In the embodiment illustrated in FIG. 1 and described throughout much of this specification, the electronic activity processing application 158 may receive electronic activity data from the user devices, i.e., the first networked device 104 and the second networked device 164. In some embodiments, the processing system 108 may retrieve user authentication information, capture device information, financial information, identifiers, and the like from the user devices (first networked device 104 and the second networked device 164) and/or the recipient system 106. In this way, the electronic activity processing application 158 may communicate with the recipient system 106, the user devices (first networked device 104 and the second networked device 164), secondary system 110, merchant systems, and other third-party systems.

In some embodiments, the electronic activity processing application 158 may control the functioning of the first networked device 104 and the second networked device 164. In some embodiments, the electronic activity processing application 158 may comprise computer readable instructions 154 or computer-readable program code, that when executed by the processing device 148, causes the processing device to perform one or more steps described herein and/or transmit control instructions to other systems and devices to cause the systems and devices to perform specific tasks. For example, the electronic activity processing application 158 may initiate a transfer of resources from a first resource to a second resource.

As illustrated in FIG. 1, the recipient system 106 is connected to the processing system 108 and may be associated with a financial institution network (e.g., a recipient bank for a resource transfer activity, an account transfer electronic activity, and the like). The recipient system 106 may refer to a financial institution system, a transaction terminal or other devices or systems associated with performing the activity. In this way, while only one recipient system 106 is illustrated in FIG. 1, it is understood that multiple network systems may make up the system environment 100. In some embodiments, the recipient system 106 is substantially similar to the processing system 108. The recipient system 106 generally comprises a communication device 136, a processing device 138, and a memory device 140. The recipient system 106 comprises computer-readable instructions 142 stored in the memory device 140, which in one embodiment includes the computer-readable instructions 142 of a finalization authorization application 144. In some embodiments, the processing system 108 (e.g., based on executing the application 158) transmits and/or causes the processing device 138 to install/store the finalization authorization application 144 on the recipient system 106. In some embodiments, the finalization authorization application 144, when executed by the processing device 138 is configured to cause the recipient system 106 to perform one or more steps described herein (e.g., transfer resources from a first resource to a second resource). In some embodiments, the finalization authorization application 144 is similar to the electronic activity processing application 158 described above. The recipient system 106 may communicate with the processing system 108 to receive static activity data sets, indicate processing of static activity data sets, indicate completion of an electronic activity, request validation of authentication credentials, confirm a resource transfer, and the like. The processing system 108 may communicate with the recipient system 106 via a secure connection 160 generated for secure encrypted communications between the two systems. In some embodiments, the secure connection 160 may be an operative communication link/channel established via the network 101.

It is understood that the servers, systems, and devices described herein illustrate one embodiment of the invention. It is further understood that one or more of the servers, systems, and devices can be combined in other embodiments and still function in the same or similar way as the embodiments described herein.

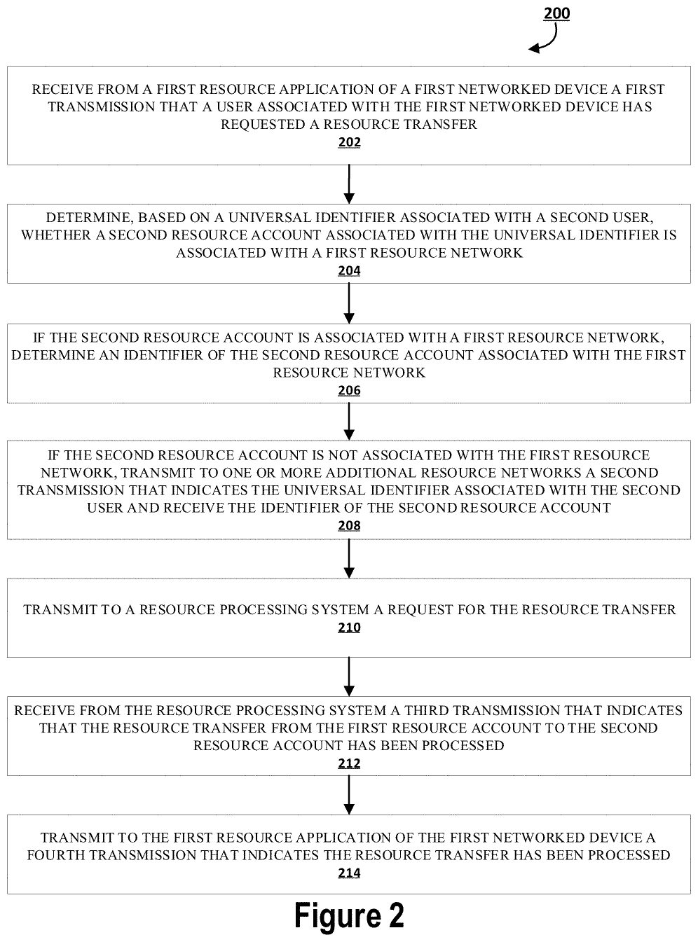

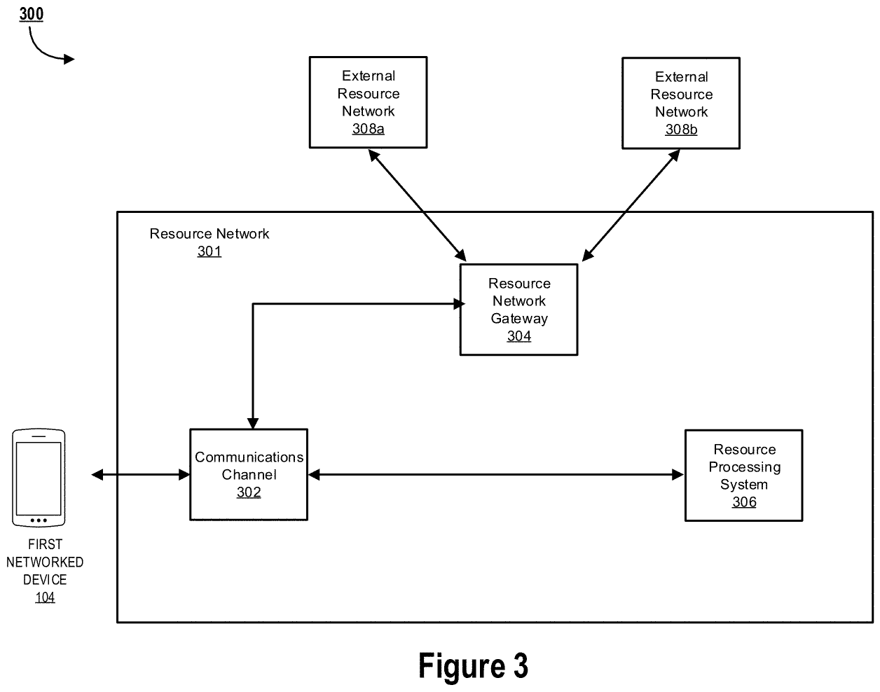

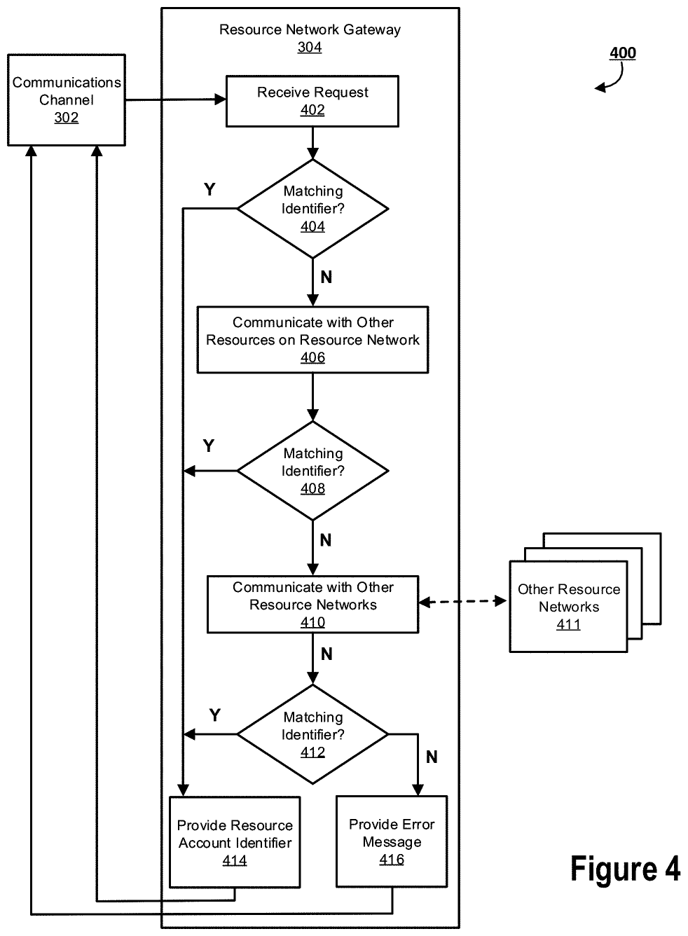

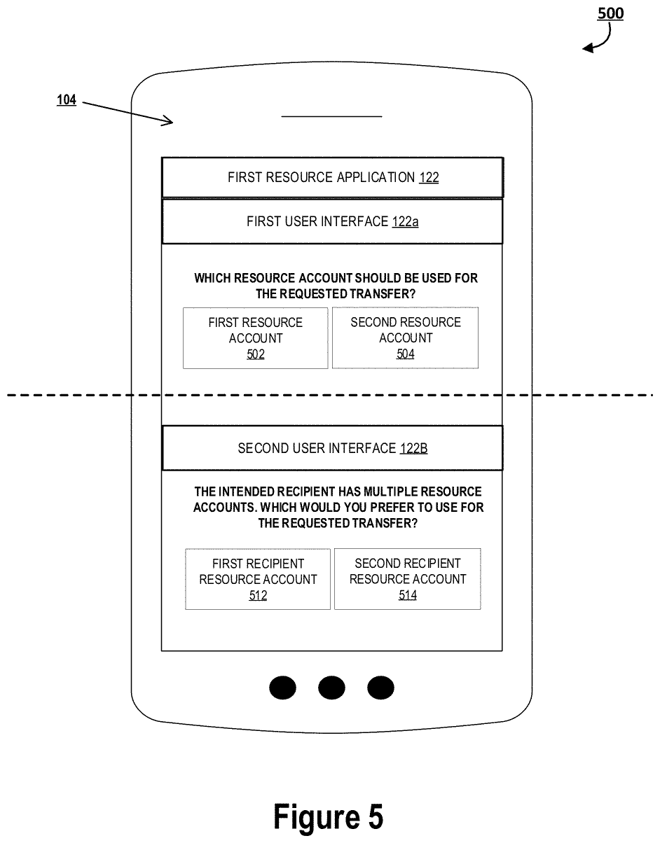

FIG. 2 illustrates a high-level process flow 200 for utilizing one or more technology resource identifiers to establish cross-network communications to facilitate one or more resource transfer activities via one or more communications networks. In some embodiments, the “system” as used herein may refer to the processing system 108, whose activities may be performed based on executing computer readable/executable instructions of the electronic activity processing application 158 by the processing device 148, the first networked device 104, the second networked device 164, the system 300 of FIG. 3, and/or the system 400 of FIG. 4. FIG. 3 schematically depicts an illustrative representation and processing environment 300 for utilizing one or more technology resource identifiers to establish cross-network communications to facilitate one or more resource transfer activities via one or more communications networks, in accordance with some embodiments of the invention. FIG. 4 schematically depicts an illustrative representation and processing environment 400 for utilizing one or more technology resource identifiers to establish cross-network communications to facilitate one or more resource transfer activities via one or more communications networks. FIG. 5 schematically depicts an illustrative representation 500 of a resource application user interface, in accordance with some embodiments of the invention. The steps, features and components of the invention for utilizing one or more technology resource identifiers to establish cross-network communications to facilitate one or more resource transfer activities via one or more communications networks will now be described in conjunction with FIGS. 2 and 3.

As illustrated by block 202 of FIG. 2, the system may receive a first transmission that a user associated with a first networked device (e.g., the first networked device 104 of FIG. 1) that a user associated with the first networked device has requested a resource transfer. For example, the user may utilize the first resource application 122 on the first networked device 104 to send the request to the system. The request may be for a resource transfer from a first resource account to a second resource account. The second resource account may be associated with a person and/or entity separate from the user.

At block 204, the system may determine, based on a universal identifier associated with a second user, whether a second resource account associated with the universal identifier is associated with a first resource network. For example, when the user associated with the first networked device 104 sends the request for the resource transfer to the system, the request may include the universal identifier associated with the second user. The second user may be the intended recipient of the resource transfer. The universal identifier may be an identifier that identifies a person and/or entity across one or more electronic networks. The universal identifier may be a government provided identifier such as a driver's license, a social security number, an Aadhaar number, a passport number, and so forth. Thus, the universal identifier can be utilized to identify the second user outside of the confines of a resource transfer.

By utilizing the universal identifier, the resource transfer can be easily initiated by the first user. For example, when a person and/or entity desires to initiate a resource transfer from one resource account to another (e.g., a transfer from one banking account to another banking account associated with a different person), the person and/or entity needs to know specific details about the account out of the person's control in order to initiate the transfer. However, this can be difficult as most people do not know an account number off the top of their head, and if they have more than one bank account, they may need to know multiple account numbers to ensure the resource transfer is handled appropriately. Thus, by utilizing the universal identifier, the first user can initiate a resource transfer without needing to know the account information of the second user. Further, the second user may have their respective universal identifier memorized or they may be able to quickly access the universal identifier.

At block 206, if the second resource account is associated with a first resource network, the system may determine an identifier of the second resource account associated with the first resource network. For example, the communications channel 302 may be configured to transmit communications for the resource network 301. The communications channel 302 may receive the resource transfer request from the first networked device 104. The communications channel 302 may analyze the request to determine the intended destination for the request. For example, if the request comprises all the information (e.g., resource account numbers, routing numbers, and the like) that would allow a resource processing system (e.g., the resource processing system 306) to execute the transfer, the communications channel 302 may transmit the request to the resource processing system 306 for the request to be processed. However, if the request comprises a universal identifier of an intended recipient instead of information associated with the resource account, the communications channel 302 may transmit the request to the resource network gateway 304.

The resource network gateway 304 may be configured to determine resource account identifiers associated with one or more resource networks based on a universal identifier. The resource network gateway 304 may comprise at least a processor, memory, and a network interface. The resource network gateway 304 may receive a request from the first networked device 104 via the communications channel 302. The request may include a universal identifier associated with a person and/or an entity. The resource network gateway 304 may search a database associated with the resource network gateway 304 to determine whether the universal identifier in the request is associated with a resource account of the resource network 301. The resource network gateway 304 may comprise the database or the database may be external to the resource network gateway 304. If the resource network gateway 304 determines a resource account associated with the universal identifier, the resource network gateway 304 may transmit information associated with the resource account to the resource processing system 306 via the communications channel 302 to facilitate the requested resource transfer. However, if the resource network gateway 304 is unable to determine a resource account associated with the universal identifier, the resource network gateway 304 may communicate with one or more external resource networks 308a and 308b to determine a resource account associated with the universal identifier, as will be discussed further with regards to block 208.

The resource network gateway 304 may communicate with the first networked device 104 via the communications channel 302. For example, if the resource network gateway 304 determines that there is more than one resource account associated with the universal identifier, the resource network gateway 304 may transmit a message to the first networked device 104 inquiring as to which of the two or more resource accounts that the user of the first networked device 104 desires to initiate the resource transfer with. The first networked device 104 may transmit a message to the system indicating which resource account to proceed with the resource transfer. The system may then facilitate the resource transfer based on the transmission from the first networked device 104.

At block 208, if the second resource account is not associated with the first resource network, the system may transmit to one or more additional resource networks a second transmission that indicates the universal identifier associated with the second user and receive the identifier of the second resource account. The resource network gateway 304 may be configured to utilize one or more communication protocols. For example, each of the external resource networks 308a,b may have a respective communication protocol. Accordingly, in order for the resource network gateway 304 to communicate with the external resource networks 308a,b, the resource network gateway 304 can utilize the respective communication protocols to communicate with the external resource networks 308a,b. The resource network gateway 304 may transmit a request to the external resource networks 308a,b to determine whether either of the external resource networks 308a,b have a resource account associated with the universal identifier. If the external resource networks 308a,b identify a resource account associated with the universal identifier, the resource network gateway 304 may transmit a messaged to the resource processing system 306 that includes the identified resource account in order to facilitate the resource transfer. If the external resource networks 308a,b are unable to identifier a resource account associated with the universal identifier, the resource network gateway 304 may transmit an error messaged to the first networked device 104 via the communications channel 302. The error message may indicate that no resource account was found that was associated with the universal identifier.

At block 210, the system may transmit to a resource processing system a request for the resource transfer. For example, if the resource network gateway 304 determines a resource account associated with the universal identifier, the resource network gateway 304 may send a message to the resource processing system 306 that indicates the determined resource account. The message may also include information associated with the resource transfer request received from the first networked device 104. After receiving the determined resource account and the transfer request, the resource processing system 306 may facilitate the transfer of resource from a resource account associated with the user of the first networked device 104 to the resource account determined by the resource network gateway 304.

At block 212, the system may receive from the resource processing system a third transmission that indicates that the resource transfer from the first resource account to the second resource account has been processed. For example, once the resource processing system 306 has processed the resource transfer, the resource processing system 306 may transmit a message to the communications channel 302 that indicates the resource transfer has successfully process or has failed to process due to one or more errors.

At block 214, the system may transmit to the first resource application of the first networked device a fourth transmission that indicates the resource transfer has been processed. For example, after the communications channel 302 receive the message from the resource processing system 306, the communications channel 302 may transmit a message to the first networked device 104 that indicates whether the resource transfer failed or successfully processed.

FIG. 4 schematically depicts an illustrative representation and processing environment 400 of the resource network gateway 304, in accordance with some embodiments of the invention. At block 402, the resource network gateway 304 may receive a request from the communications channel 302. The request may be a resource transfer request that comprises a universal identifier. The request may also include contextual data associated with at least one of a networked device or a user of the networked device. The resource network gateway 304 may utilize the contextual data to help determine a resource account associated with the universal identifier.

At block 404, the resource network gateway 304 determines whether there is a resource account that is associated with the universal identifier by utilizing a memory and/or a database associated with the resource network gateway 304. The memory and/or the database may be associated with a resource network that comprises the resource network gateway 304. Stated differently, the resource network may be an internal resource network associated with the resource network gateway 304. If there is a resource account that matches the identifier, the resource network gateway 304 proceeds to block 414 and provides the resource account identifier to the communications channel 302. If there is not a resource account associated with the universal identifier, the resource network gateway 304 proceeds to block 406.

At block 406, the resource network gateway can communicate with one or more other resources on the resource network. For example, the resource network may comprise a plurality of distributed resource network gateways 304, and the resource network gateway 304 may communicate with the one or more of other distributed resource network gateways 304 to determine if there is a resource account on the resource network that is associated with the universal identifier. The resource network gateway 304 may transmit a request to the one or more other resources on the resource network for a resource account associated with the universal identifier. If the resource network gateway 304 receives a resource account associated with the universal identifier at block 408, the resource network gateway 304 proceeds to block 414 and provides the resource account identifier to the communications channel 302. If there is not a resource account associated with the universal identifier, the resource network gateway 304 proceeds to block 410.

At block 410, the resource network gateway 304 communicates with one or more other resource networks 411. For example, the resource network gateway 304 may request if the universal identifier is associated with a resource account. If the resource network gateway 304 receives a resource account associated with the universal identifier at block 412, the resource network gateway 304 proceeds to block 414 and provides the resource account identifier to the communications channel 302. If there is not a resource account associated with the universal identifier, the resource network gateway 304 proceeds to block 416 and provides an error message indicating that no resource account could be found that is associated with the universal identifier.

FIG. 5 schematically depicts an illustrative representation of a resource application user interface 500, in accordance with some embodiments of the invention. The first networked device 104 may display on a screen the first resource application 122. The first resource application 122 can facilitate a resource transfer for a user of the first networked device 104. The first resource application 122 can have a first user interface 122a. For example, the first user interface 122a can prompt a user of the networked device 104 whether to use a first resource account 502 or a second resource account 504 associated with the user for the resource transfer. The user may input a response via an input device such as a touchscreen, keyboard, pointing device, and the like or verbally to a microphone of the first networked device 104.

The first resource application 122 can have a second user interface 122b. For example, the second user interface 122b can prompt a user of the networked device 104 whether to use a first recipient resource account 512 or a second recipient resource account 514 associated with the recipient of the resource transfer. The user may input a response via an input device such as a touchscreen, keyboard, pointing device, or verbally to a microphone of the first networked device 104.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for processing technology resource identifiers and establishing dynamic context-based cross-network communications for resource transfer activities, the system comprising:
at least one memory device;
at least one communication device connected to a communications network;
at least one processing device operatively coupled to the at least one memory device; and
a module stored in the at least one memory device comprising executable instructions that when executed by the at least one processing device, cause the at least one processing device to:
receive from a first resource application of a first networked device a first transmission that a first user associated with the first networked device has requested a resource transfer, wherein the first transmission indicates a quantity of a resource to transfer from a first resource account associated with a first resource network, and wherein the first transmission indicates a universal identifier associated with a second user;
determine, based on the universal identifier associated with the second user, whether a second resource account associated with the universal identifier is associated with the first resource network;
if the second resource account is associated with the first resource network, determine an identifier of the second resource account associated with the first resource network;
if the second resource account is not associated with the first resource network:
transmit to one or more additional resource networks a second transmission that indicates the universal identifier associated with the second user, and
receive from at least one of the one or more additional resource networks the identifier of the second resource account associated with the second user;
transmit to a resource processing system a request for the resource transfer, wherein the request comprises an identifier associated with the first resource account, the identifier associated with the second resource account, and the quantity of the resource to transfer from the first resource account to the second resource account;
receive from the resource processing system a third transmission that indicates that the resource transfer from the first resource account to the second resource account has been processed; and
transmit to the first resource application of the first network device a fourth transmission that indicates the resource transfer has been processed.

2. The system of claim 1, wherein if the second resource account is not associated with the first resource network, the executable instructions further cause the at least one processing device to:
determine contextual data associated with the first user and the requested resource transfer;
determine, based on the contextual data, a probable additional resource network of the one or more additional resource networks that is more likely to be associated with the second resource account;
transmit to the probable additional resource network the universal identifier associated with the second user; and
receive from the probable additional resource network the identifier of the second resource account associated with the second user.

3. The system of claim 2, wherein the contextual data comprises at least one of a location associated with the first user, a location associated with the second user, a location associated with the first networked device, a time associated with the first transmission, a language associated with the first user, or a language associated with the second user; and wherein determine, based on the contextual data, the probable additional resource network of the one or additional resource network further comprises utilizing machine learning to determine, based on the contextual data, the probable additional resource network.

4. The system of claim 1, wherein the first transmission includes a universal identifier associated with the first user, and wherein the executable instructions further cause the at least one processing device to:
determine, based on the universal identifier associated with the first user, two or more resource accounts associated with the first user,
transmit to the first networked device a request for the first user to indicate a preferred resource account of the two or more resource accounts associated with the first user to utilize for the resource transfer,
receive from the first network device a fifth transmission that indicates the preferred resource account, and
determine an identifier associated with the preferred resource account, wherein the identifier associated with the preferred resource account is transmitted to the resource processing system.

5. The system of claim 1, wherein the executable instructions further cause the at least one processing device to:
determine, based on the universal identifier associated with the second user, two or more resource accounts associated with the second user,
transmit to the first networked device a request for the first user to indicate a preferred resource account of the two or more resource accounts associated with the second user to utilize for the resource transfer,
receive from the first network device a fifth transmission that indicates the preferred resource account, and
determine an identifier associated with the preferred resource account, wherein the identifier associated with the preferred resource account is transmitted to the resource processing system.

6. The system of claim 1, wherein the executable instructions further cause the at least one processing device to:
determine, based on the universal identifier associated with the second user, two or more resource accounts associated with the second user,
transmit to a second networked device associated with the second user a request for the user to indicate a preferred resource account of the two or more resource accounts associated with the second user to utilize for the resource transfer,
receive from the second networked device a fifth transmission that indicates the preferred resource account, and
determine an identifier associated with the preferred resource account, wherein the identifier associated with the preferred resource account is transmitted to the resource processing system.

7. The system of claim 1, wherein the executable instructions that cause the at least one processing device to, if the second resource account is not associated with the first resource network, transmit to the one or more additional resource networks the second transmission, further comprises:
determine a respective communications protocol for each of the one or more additional resource networks,
determine, based on the respective communications protocols, a respective second transmission for each of the one or more additional resource networks,
transmit the respective second transmissions for each of the one or more additional resource networks, and
receive from at least one of the additional resource networks the identifier of the second resource account.

8. A computer program product for processing technology resource identifiers and establishing dynamic context-based cross-network communications for resource transfer activities, the computer program product comprising a non-transitory computer-readable storage medium having computer-executable instructions to:
receive from a first resource application of a first networked device a first transmission that a first user associated with the first networked device has requested a resource transfer, wherein the first transmission indicates a quantity of a resource to transfer from a first resource account associated with a first resource network, and wherein the first transmission indicates a universal identifier associated with a second user;
determine, based on the universal identifier associated with the second user, whether a second resource account associated with the universal identifier is associated with the first resource network;
if the second resource account is associated with the first resource network, determine an identifier of the second resource account associated with the first resource network;
if the second resource account is not associated with the first resource network:
transmit to one or more additional resource networks a second transmission that indicates the universal identifier associated with the second user, and
receive from at least one of the one or more additional resource networks the identifier of the second resource account associated with the second user;
transmit to a resource processing system a request for the resource transfer, wherein the request comprises an identifier associated with the first resource account, the identifier associated with the second resource account, and the quantity of the resource to transfer from the first resource account to the second resource account;
receive from the resource processing system a third transmission that indicates that the resource transfer from the first resource account to the second resource account has been processed; and
transmit to the first resource application of the first network device a fourth transmission that indicates the resource transfer has been processed.

9. The computer program product of claim 8, wherein if the second resource account is not associated with the first resource network, the computer program product further comprises computer-executable instructions to:
determine contextual data associated with the first user and the requested resource transfer;
determine, based on the contextual data, a probable additional resource network of the one or more additional resource networks that is more likely to be associated with the second resource account;
transmit to the probable additional resource network the universal identifier associated with the second user; and
receive from the probable additional resource network the identifier of the second resource account associated with the second user.

10. The computer program product of claim 9, wherein the contextual data comprises at least one of a location associated with the first user, a location associated with the second user, a location associated with the first networked device, a time associated with the first transmission, a language associated with the first user, or a language associated with the second user; and wherein determine, based on the contextual data, the probable additional resource network of the one or additional resource network further comprises utilizing machine learning to determine, based on the contextual data, the probable additional resource network.

11. The computer program product of claim 8, wherein the first transmission includes a universal identifier associated with the first user, and wherein the computer program product further comprises computer-executable instructions to:
determine, based on the universal identifier associated with the first user, two or more resource accounts associated with the first user,
transmit to the first networked device a request for the first user to indicate a preferred resource account of the two or more resource accounts associated with the first user to utilize for the resource transfer,
receive from the first network device a fifth transmission that indicates the preferred resource account, and
determine an identifier associated with the preferred resource account, wherein the identifier associated with the preferred resource account is transmitted to the resource processing system.

12. The computer program product of claim 8, wherein the computer program product further comprises computer-executable instructions to:
determine, based on the universal identifier associated with the second user, two or more resource accounts associated with the second user,
transmit to the first networked device a request for the first user to indicate a preferred resource account of the two or more resource accounts associated with the second user to utilize for the resource transfer,
receive from the first network device a fifth transmission that indicates the preferred resource account, and
determine an identifier associated with the preferred resource account, wherein the identifier associated with the preferred resource account is transmitted to the resource processing system.

13. The computer program product of claim 8, wherein the computer program product further comprises computer-executable instructions to:
determine, based on the universal identifier associated with the second user, two or more resource accounts associated with the second user,
transmit to a second networked device associated with the second user a request for the user to indicate a preferred resource account of the two or more resource accounts associated with the second user to utilize for the resource transfer,
receive from the second networked device a fifth transmission that indicates the preferred resource account, and
determine an identifier associated with the preferred resource account, wherein the identifier associated with the preferred resource account is transmitted to the resource processing system.

14. The computer program product of claim 8, wherein the computer program product that comprises computer-executable instructions to, if the second resource account is not associated with the first resource network, transmit to the one or more additional resource networks the second transmission, further comprises:
determine a respective communications protocol for each of the one or more additional resource networks,
determine, based on the respective communications protocols, a respective second transmission for each of the one or more additional resource networks,
transmit the respective second transmissions for each of the one or more additional resource networks, and
receive from at least one of the additional resource networks the identifier of the second resource account.

15. A computerized method for processing technology resource identifiers and establishing dynamic context-based cross-network communications for resource transfer activities, the computerized method comprising:
receiving from a first resource application of a first networked device a first transmission that a first user associated with the first networked device has requested a resource transfer, wherein the first transmission indicates a quantity of a resource to transfer from a first resource account associated with a first resource network, and wherein the first transmission indicates a universal identifier associated with a second user;
determining, based on the universal identifier associated with the second user, whether a second resource account associated with the universal identifier is associated with the first resource network;
if the second resource account is associated with the first resource network, determining an identifier of the second resource account associated with the first resource network;
if the second resource account is not associated with the first resource network:
transmitting to one or more additional resource networks a second transmission that indicates the universal identifier associated with the second user, and
receiving from at least one of the one or more additional resource networks the identifier of the second resource account associated with the second user;
transmitting to a resource processing system a request for the resource transfer, wherein the request comprises an identifier associated with the first resource account, the identifier associated with the second resource account, and the quantity of the resource to transfer from the first resource account to the second resource account;
receiving from the resource processing system a third transmission that indicates that the resource transfer from the first resource account to the second resource account has been processed; and
transmitting to the first resource application of the first network device a fourth transmission that indicates the resource transfer has been processed.

16. The computerized method of claim 15, wherein if the second resource account is not associated with the first resource network, the computerized method further comprises:
determining contextual data associated with the first user and the requested resource transfer;
determining, based on the contextual data, a probable additional resource network of the one or more additional resource networks that is more likely to be associated with the second resource account;
transmitting to the probable additional resource network the universal identifier associated with the second user; and
receiving from the probable additional resource network the identifier of the second resource account associated with the second user.

17. The computerized method of claim 16, wherein the contextual data comprises at least one of a location associated with the first user, a location associated with the second user, a location associated with the first networked device, a time associated with the first transmission, a language associated with the first user, or a language associated with the second user; and wherein determine, based on the contextual data, the probable additional resource network of the one or additional resource network further comprises utilizing machine learning to determine, based on the contextual data, the probable additional resource network.

18. The computerized method of claim 15, wherein the first transmission includes a universal identifier associated with the first user, and wherein the computerized method further comprises:
determining, based on the universal identifier associated with the first user, two or more resource accounts associated with the first user,
transmitting to the first networked device a request for the first user to indicate a preferred resource account of the two or more resource accounts associated with the first user to utilize for the resource transfer,
receiving from the first network device a fifth transmission that indicates the preferred resource account, and
determining an identifier associated with the preferred resource account, wherein the identifier associated with the preferred resource account is transmitted to the resource processing system.

19. The computerized method of claim 15, wherein the computerized method further comprises:
determining, based on the universal identifier associated with the second user, two or more resource accounts associated with the second user,
transmitting to the first networked device a request for the first user to indicate a preferred resource account of the two or more resource accounts associated with the second user to utilize for the resource transfer,
receiving from the first network device a fifth transmission that indicates the preferred resource account, and
determining an identifier associated with the preferred resource account, wherein the identifier associated with the preferred resource account is transmitted to the resource processing system.

20. The computerized method of claim 15, wherein if the second resource account is not associated with the first resource network, transmitting to the one or more additional resource networks the second transmission further comprises:
determining a respective communications protocol for each of the one or more additional resource networks,
determining, based on the respective communications protocols, a respective second transmission for each of the one or more additional resource networks,
transmitting the respective second transmissions for each of the one or more additional resource networks, and
receiving from at least one of the additional resource networks the identifier of the second resource account.
